(19) United States
(12) Patent Application Publication
(10) Pub. No.: US 2021/0382883 A1
(43) Pub. Date: Dec. 9, 2021

(54) INFORMATION PROCESSING APPARATUS, TERM SEARCH METHOD, AND PROGRAM

(71) Applicant: KONICA MINOLTA, INC., Tokyo (JP)

(72) Inventors: Shimpei ITAYA, Tokyo (JP); Yusuke MIKOSHIBA, Toyokawa-shi (JP)

(73) Assignee: KONICA MINOLTA, INC., Tokyo (JP)

(21) Appl. No.: 17/236,106

(22) Filed: Apr. 21, 2021

(30) Foreign Application Priority Data
Jun. 4, 2020 (JP) 2020-097750

(51) Int. Cl. G06F 16/248; G06F 16/2455

(52) U.S. Cl. CPC G06F 16/248; G06F 16/2455

(57) ABSTRACT

An information processing apparatus includes: a communicator that receives a search instruction for a term generated based on an instruction uttered by a user; and a search executor that performs search targeting each piece of information associated with a plurality of attributes in information management data in which the plurality of attributes is associated with information related to the term by using the term contained in the search instruction received by the communicator as a keyword, and outputs a search result to the communicator and/or a display.

The entire disclosure of Japanese patent Application No. 2020-097750, filed on Jun. 4, 2020, is incorporated herein by reference in its entirety.

### BACKGROUND

### Technological Field

The present invention relates to an information processing apparatus, a term search method, program.

### Description of the Related art

in recent years, speakers with artificial intelligence (AI) assistant functions, called smart speakers (AI speakers), have been developed and linked with various devices such as home appliances. As a result, users can operate a device by voice through a smart speaker, and acquire data of the device from the smart speaker.

For example, even in multifunction peripherals (MFPs), a smart speaker is used as an input device for voice of a user. Users can continuously enjoy the benefits of the latest AI functions through cloud service by using a smart speaker linked to the cloud service provided by a company as a device for voice input.

Voice uttered by a user (hereinafter, also referred to as “uttered voice”) is converted into voice data by a smart speaker, converted into text data of kanji, hirafana, katakana, alphabet, number, and the like by a voice analysis server, and then transmitted to a device. For example, when an instruction to search an address book for a name “KONICA MINOLTA” is input by a voice operation, text data composed of the alphabets of “Konicatninolta” may be input from the voice analysis server to the device. In the case, if the name of “KONICA MINOLTA” is registered in katakana in the address book, the device erroneously determines that there is no corresponding search result.

As a method for solving such collation inconsistencies in search, for example, Japanese Patent Application Laid-Open No. 2010-147624 discloses a technique for extracting an entry that contains a first search term in “reading” and a second search term in “name” from entries registered in an address book. The first search term is a recognition result obtained by voice recognition processing. The second search term is kanji obtained by kana-kanji conversion processing to a character capable of being received at a character input.

Unfortunately, in the technique described in Japanese Patent Application Laid-Open No. 2010-147624, a user needs to input a character to a character input or addition to inputting voice to a smart speaker, which is troublesome.

### SUMMARY

The invention has been made in view of such a situation. An object of the invention is to enable accurate term search by voice operation without trouble of a user.

To achieve the abovementioned object, according to an aspect of the present invention, an information processing apparatus reflecting one aspect of the present invention comprises: a communicator that receives a search instruction for a term generated based on an instruction uttered by a user; and a search executor that performs search targeting each piece of information associated with a plurality of attributes in information management data in which the plurality of attributes is associated with information related to the term by using the term contained in the search instruction received by the communicator as a keyword, and outputs a search result to the communicator and/or a display.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic configuration diagram aim image processing system according to one embodiment of the invention;

FIG. 2 is a block diagram illustrating a configuration example of a control system of an image forming apparatus, a voice input output apparatus, and a voice processing server included in the image processing system according to one embodiment of the invention;

FIG. 3 illustrates a configuration example of an address book according to one embodiment of the invention;

FIG. 4 is a sequence diagram illustrating an example of a procedure of voice response processing performed by the image processing system according to one embodiment of the invention;

FIG. 5 is a flowchart illustrating an example of a procedure of address search processing according to Example 1 of one embodiment of the invention;

FIG. 6 is a flowchart illustrating an example of a procedure of the address search processing according to a variation of Example 1 of one embodiment of the invention;

FIG. 7 illustrates a configuration example of a search target attribute table used in Example 2 of one embodiment of the invention:

FIG. 8 illustrates a configuration example of an attribute search order table used in Example 3 of one embodiment of the invention; and

FIG. 9 is a flowchart illustrating an example of a procedure of address search processing according to Example 3 of one embodiment of the invention.

### DETAILED DESCRIPTION OF EMBODIMENTS

Hereinafter, one or more embodiments of the present invention will be described with reference to the drawings. However, the scope of the invention is not limited to the disclosed embodiments. In the present specification and drawings, components having substantially the same function or configuration are denoted by the same signs, and duplicate description of the components will be omitted.

<Configuration of Image Processing System>

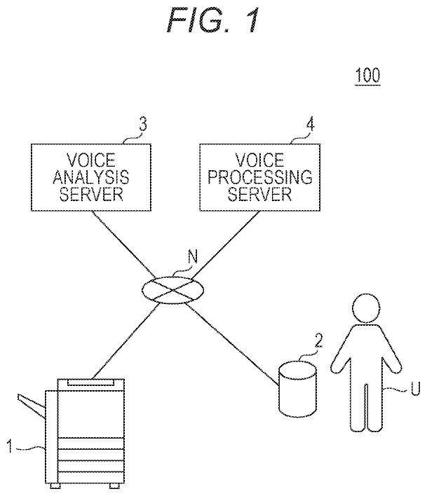

First, the configuration of an image processing system according to one embodiment of the invention will be described with reference to FIG. 1. FIG. 1 is a schematic configuration diagram of an image processing system 100 according to one embodiment of the invention. Note that FIG. 1 describes elements considered necessary for the description of the invention or related elements thereof, and an image forming system of the invention is not limited to the example in FIG. 1.

The image processing system 100 in FIG. 1 includes an image forming apparatus 1 (one example of information processing apparatus), a voice input/output apparatus 2, a voice analysis server 3, and a voice processing server 4. The mage forming apparatus 1, the voice input/output apparatus 2, the voice analysis server 3, and the voice processing server 4 are connected to each other via a network N including a public switched telephone network and an Internet Protocol (IP) network.

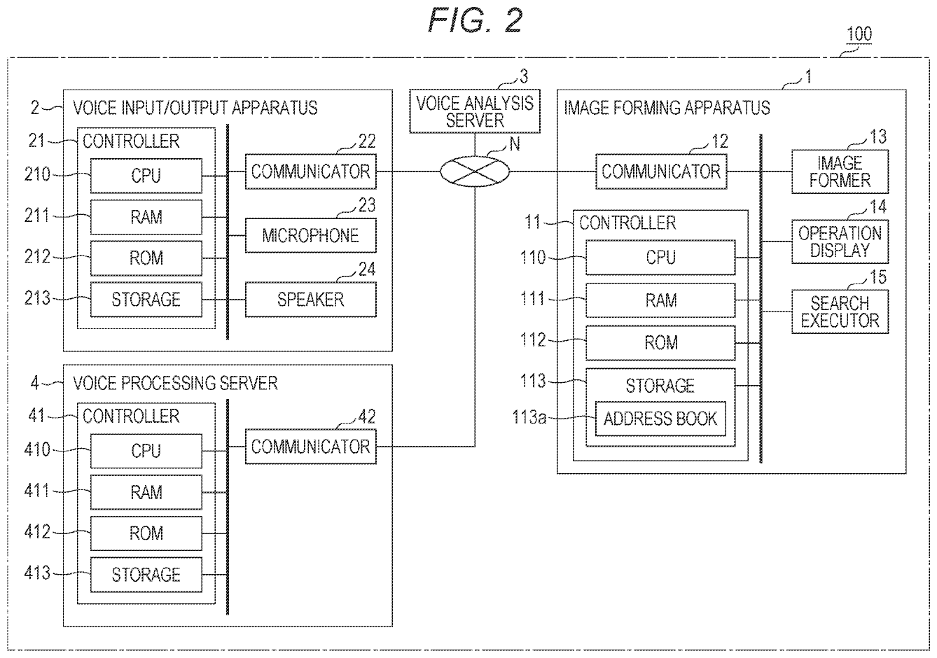

For example, the image forming apparatus 1 includes an MFP having a copy function, a printer function, and a scanner function. The image forming apparatus 1 forms an image on paper based on image data contained in a job transmitted from, for example, a printer controller (not illustrated), and outputs the paper on which the image is formed as printed matter. A job execution instruction to the image forming apparatus 1 is given by, for example, an operation from a user U to an operation display 14 (see FIG. 2) provided in the image forming apparatus 1 and a voice operation from the user U to the voice input/output apparatus 2.

The image forming apparatus 1 manages an address book (one example of information management data) in which information on an address such as an e-mail address is recorded. When an instruction to set a destination of data desired by a user as an address associated with a name (one example of terms) specified by the user is given via a voice operation to the operation display 14 or the voice input/output apparatus 2, the image forming apparatus 1 first searches the address book by using the name for which an instruction for search is given as a keyword. When the address associated with the name is found, the image forming apparatus 1 transmits the search result to the voice analysis server 3 via the. voice processing server 4. The search result transmitted to the voice analysis server 3 is transmitted to the voice input/output apparatus 2. As a result, the user is notified of the search result from the voice input/output apparatus 2. When the user inputs a data transmission instruction having the search result as an address by, for example, a voice operation, the image forming apparatus 1 transmits the data to the set address.

For example, the voice input/output apparatus 2 includes a smart speaker, and includes a microphone 23 and a speaker 24 (see FIG. 2 for both). The voice input/output apparatus 2 may be installed in the vicinity of the image forming apparatus 1, or may be disposed, for example, near a desk of the user U.

The voice input/output apparatus 2 converts voice collected by the microphone 23, for example, an instruction uttered by the user U into voice data, and transmits the voice data to the voice analysis server 3. The voice input/output apparatus 2 reproduces the voice data transmitted from the voice processing server 4, and outputs the voice data from the speaker 24.

For example, the user U can give an instruction such as “set a transmission address to “TOYOTA”” to the image forming apparatus 1 by a voice operation to the voice input/output apparatus 2.

The voice analysis server 3 is provided on, for example, a cloud (not illustrated). The voice analysis server 3 performs voice analysis processing on the voice data transmitted from the voice input/output apparatus 2, and converts the voice data into text data. The voice analysis server 3 transmits action information obtained by the analysis and the text data to the voice processing server 4. The action information corresponds to an operation instruction to the image forming apparatus 1, and includes the above-described “address search”, and “address setting”, a selection instruction in apparatus setting, a selection instruction in print setting, and an instruction to execute a job.

The voice processing server 4 is provided on, for example, a cloud (not illustrated). The voice processing server 4 analyzes the action information transmitted from the voice analysis server 3, and replaces the analyzed contents with information on a job that can be executed by the image forming apparatus 1. The voice processing server 4 transmits the job information to the image forming apparatus 1. When the job information transmitted by the voice processing server 4 to the image forming apparatus 1 is an address setting instruction, the voice processing server 4 transmits the job information while causing the job information to contain the text data of a name for which an instruction for address search is given. The name for which an instruction for address search is given is indicated by text data such as “Toyota” obtained by converting the utterance of “TOYOTA” of the user U.

The voice processing server 4 converts the instruction transmitted front the image forming apparatus 1 into, for example, text data, and transmits the text data to the voice analysis server 3.

Although, in the embodiment, an example in which the voice processing server 4 is provided on a cloud has been described, the invention is not limited thereto. The voice processing server 4 may be provided inside an on-premises server (not illustrated), for example.

<Configuration of Control System of Image Forming Apparatus and Voice Input/Output Apparatus Constituting Image Processing System>

A configuration example of a control system of the image forming apparatus 1, the voice input/output apparatus 2, and the voice processing server 4 included in the image processing system 100 will now be described with reference to FIG. 2. FIG. 2 is a block diagram illustrating a configuration example of the control system of the image forming apparatus 1, the voice input/output apparatus 2, and the voice processing server 4 included in the image processing system 100.

[Configuration of Control System of Voice Input/Output Apparatus]

First, the configuration of a control system of the voice input/output apparatus 2 will be described. As illustrated in FIG. 2, the voice input/output apparatus 2 includes a controller 21, a communicator 22, the microphone 23, and the speaker 24. The controller 21 includes a central processing unit (CPU) 210, a random access memory (RAM) 211, a read only memory (ROM) 212, and a storage 213.

The CPU 210 reads various processing programs such as a system program and a voice input/output processing program stored in the ROM 212, expands the programs in the RAM 211, and controls the operation of each unit of the voice input/output apparatus 2 in accordance with the expanded programs. For example, the controller 21 performs controls of transmitting voice data acquired by the microphone 23 to the voice analysis server 3 via the communicator 22 and outputting voice data, which has been transmitted from the voice processing server 4 and received by the communicator 22, from the speaker 24 as voice.

The RAM 211 forms a work area for temporarily storing various programs executed by the CPU 210 and data related to these programs, and stores, for example, job queues and settings of various operations.

The ROM 212 includes a non-volatile memory such as a semiconductor memory, and stores, for example, a system program compatible with the voice input/output apparatus 2 and a voice input/output processing program executable on the system program. These programs are stored in the form of a computer-readable program code. The CPU 210 sequentially executes operations in accordance with the program code.

The storage 213 includes a hard disk drive (HDD) and a solid state drive (SSD). The storage 213 stores, for example, various pieces of setting data related to the voice input/output apparatus 2.

The communicator 22 controls transmission/reception operations of, for example, various control signals and data performed between the image forming apparatus 1, the voice analysis server 3, and the voice processing server 4 connected via the network N.

The microphone 23 collects voice around the voice input/output apparatus 2 such as voice tittered by the user U, converts the voice into voice data, and outputs the voice data to the controller 21. The speaker 24 emits the voice data input from the controller 21 as voice.

[Configuration of Control System of Voice Processing Server]

The configuration of the control system of the voice processing server 4 will now be described with reference to FIG. 2 as well. The voice processing server 4 includes a controller 41 and a communicator 42. The controller 41 includes a CPU 410, a RAM 411, a ROM 412, and a storage 413.

The CPU 410 reads various processing programs such as a system program and a voice processing program stored in the ROM 112, expands the programs in the RAM 411, and controls the operation of each unit of the voice processing server 4 in accordance with the expanded programs.

The RAM 411 forms a work area for temporarily storing various programs executed by the CPU 410 and data related to these programs.

The ROM 412 includes a non-volatile memory such as a semiconductor memory, and stores, for example, a system program compatible with the voice processing server 4 and a voice processing program executable on the system program. These programs are stored in the form of a computer-readable program code. The CPU 410 sequentially executes operations in accordance with the program code.

The storage 413 includes an HHD and an SSD, The storage 413 stores, for example, various pieces of setting data related to the voice processing server 4.

The communicator 42 controls transmission/reception operations of various pieces of data performed between the image forming apparatus l and the voice analysis server 3 connected via the network N.

[Configuration of Control System of Image Forming Apparatus]

The configuration of a control system of the image forming apparatus 1 will now be described with reference to FIG. 2 as well. As illustrated in FIG. 2, the image forming apparatus 1 includes a controller 11, a communicator 12, an image former 13, the operation display 14, and a search executor 15.

The communicator 12 controls transmission/reception operations of various pieces of data performed with the voice processing server 4 connected via the network N.

The controller 11 includes a CPU 110, a RAM 111, a RUM 112, and a storage 113. The CPU 110 reads various processing programs such as a system program and an image formation processing program stored in the ROM 112, expands the programs in the RAM 111, and controls the operation of each unit of the image forming apparatus 1 in accordance with the expanded programs.

For example, when the voice analysis server 3 transmits job information (one example of search instruction) giving an instruction to set an address of a data destination, or when an instruction to set an address is input via time operation display 14, the CPU 110 causes the search executor 15 to search an address book using text data contained in the job information as a keyword. Note that the text data contained in the job information transmitted from the voice processing server 4 is processed in the image forming apparatus 1 in a manner equivalent to the text data such as a file name input by a user via the operation display 14.

The CPU 110 also performs controls of transmitting a search result of the search executor 15 to the voice processing server 4 via the communicator 12 and displaying the search result on a screen of the operation display 14.

The RAM 111 forms a work area for temporarily storing various programs executed by the CRU 110 and data related to these programs, and stores, for example, job queues, setting set commands, and settings of various operations.

The ROM 112 includes a non-volatile memory such as a semiconductor memory, and stores, for example, a system program compatible with the image forming apparatus 1 and an image formation processing program executable on the system program. These programs are stored in the form of a computer-readable program code. The CPU 110 sequentially executes operations in accordance with the program code.

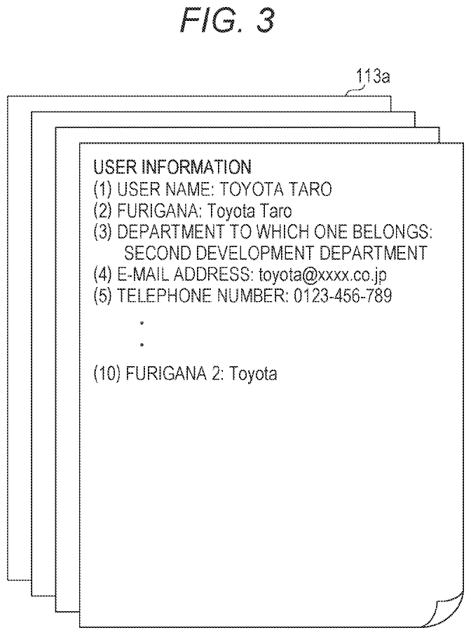

The storage 113 includes an HDD and an SSD, and stores, for example, various pieces of setting data and image data related to the image forming apparatus 1. In the embodiment, the storage 113 stores an address book 113a in which a name and an address are associated with each other. In the address book 113a according to the embodiment, information of each user is managed by information of a plurality of attributes such as “username”, “furigana”, “department to which one belongs”, “e-mail address”, and “telephone number”. A configuration example of the address book 113a will be described in detail with reference to FIG. 3 which comes next.

The image former 13 forms an image on paper based on image data transmitted from, for example, a printer controller (not illustrated), and outputs the paper on which the image is formed as printed matter. Specifically, the image former 13 includes a charging apparatus, a photosensitive drum, an exposure apparatus, a transfer belt, and a fixing apparatus (not illustrated).

The image former 13 first forms an electrostatic latent image on the periphery of the photosensitive drum by causing the exposure apparatus to apply light suitable for an image on the photosensitive drum charged by the charging apparatus. The image former 13 attaches toner on the charged electrostatic latent image by causing a developing apparatus to supply toner on the photoreceptor to develop a toner image. The image former 13 primarily transfers the toner image to the transfer belt, secondarily transfers the toner image transferred to the transfer belt to blank paper, and causes the fixing apparatus to fix the toner image, which has been transferred to the paper, on the paper.

Note that, although, in the embodiment, an example in which the image former 13 forms an image by an electrophotographic method has been described, the invention is not limited thereto. The image forming apparatus of the invention may be applied to an image forming apparatus including an image former that forms an image by another method such as an inkjet method.

The operation display 14 includes a touch panel to which a display including a liquid crystal display (LCD) and an organic electroluminescence (EL) and an operation input including a touch sensor are integrally formed. Note that although, in the embodiment, an example in which the display and the operation input are integrally formed as the operation display 14 has been described, the invention is not limited thereto. The display and the operation input unit including a keyboard and a mouse may be configured separately. In addition to the operation display 14 configured as a touch panel, an operation input including a keyboard and a mouse may be provided.

The search executor 15 performs search targeting a name attribute and a plurality of attributes other than the name attribute in the address book 113a by using text data contained in the job information transmitted from the voice processing server 4 as a keyword. The search executor 15 outputs the search result to the communicator 12 and/or the operation display 14.

[Configuration of Address Book]

The configuration of the address book 113a according to the embodiment will now be described with reference to FIG. 3. FIG. 3 illustrates a configuration example of the address book 113a.

In the example in FIG. 3, information of each attribute of “username”, “furigana”, “department to which one belongs”, “e-mail address”, “telephone number”, and “furigana 2” is maimed in the address book 113a.

In the attribute of “username” (one example of name attribute), a username is registered in kanji like “TOYOTA TARO”. In the attribute of “furigana”, the furigana of the username is registered like Toyota Taro.

In the attribute of “department to which one belongs”, a department to which the user belongs is registered as a “second development department”. in the attribute of “e-mail address”, an e-mail address of the user is registered as “toyota@xxxx.co.jp” in the attribute of “telephone number”, the telephone number of the user is registered as “0123-456-789”. In the attribute of “furigana 2”, the furigana of a pad (first name or family name) of the username is registered as “Toyota, Note that the attributes registered in the address book 113a in FIG. 3 are examples, and the invention is not limited thereto.

[Voice Response Processing Performed by Image Processing System]

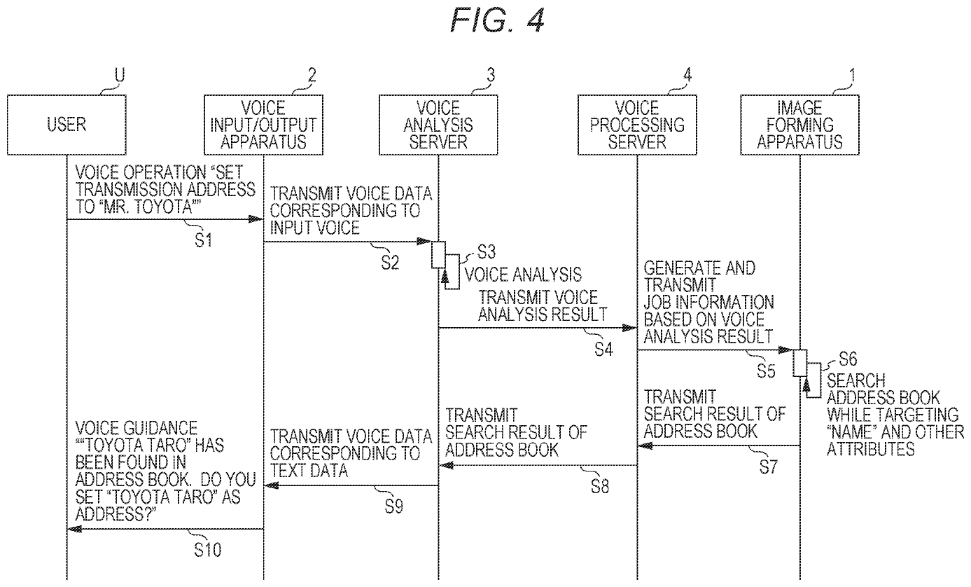

Voice response processing performed by the image processing system 100 according to one embodiment of the invention will now be outlined with reference to FIG. 4. FIG. 4 is a sequence diagram illustrating an example of a procedure of the voice response processing performed by the image processing system 100.

First, the user U (see FIG. 1) performs a voice operation by uttering “Set a transmission address to “Mr. TOYOTA”” to the voice input/output apparatus 2 (step S1). Voice data corresponding to the voice input in step S is transmitted from the voice input/output apparatus 2 to the voice analysis server 3 (step S2).

The voice analysis server 3 performs voice analysis processing (step S3). The voice analysis server 3 transmits the voice analysis result to the voice processing server 4 (step S4). Specifically, the voice analysis server 3 transmits the following information to the voice processing server 4 as the voice analysis result.

Text: “Toyota”

Action information: “Address book search”

The voice processing server 4 generates job information (instruction) to the image forming apparatus 1 based on the information transmitted from the voice analysis server 3 in step S4, and transmits the job information to the image forming apparatus 1 (step S5). In step S5, the voice processing server 4 transmits an instruction to search the address book 113a using the text “Toyota” as a keyword to the image forming apparatus 1.

The search executor 15 (see FIG. 2) of the image forming apparatus 1 searches the address book 113a by using text contained in the job information as a keyword while targeting user information (one example of information) associated with a “name” attribute and other attributes based on the job information transmitted in step S5 (step S6). That is, in step S6 the search executor 15 searches the address book 113a by using “Toyota” as a keyword while targeting the “name” attribute and each attribute of “furigana”, “e-mail address”, and “department to which one belongs”.

The controller 11 of the image forming apparatus 1 transmits the search result of the address book 113a performed in step S6 to the voice processing server 4 via the communicator 12 (step S7). For example, when “TOYOTA TARO” is found as a search result, the controller 11 transmits the fact to the voice processing server 4 as a search result.

The voice processing server 4 transmits the search result transmitted front the image forming apparatus in step S7 to the voice analysis server 3 (step S8). The voice analysis server 3 transmits the voice data indicating the search result transmitted from the voice processing server 4 in step S8 to the voice input/output apparatus 2 (step S9). The voice input/output apparatus 2 outputs voice based on the voice data transmitted from the voice analysis server 3 in step S9 to the user (step S10).

Specifically, the voice input/output apparatus 2 outputs guidance such as ““Mr. TOYOTA TARO” is found in the address book 113a. Do you want to set “Mr. TOYOTA TARO” as an address?” to the user by voice.

[Address Search Processing Performed by thine Forming Apparatus]

### EXAMPLE 1

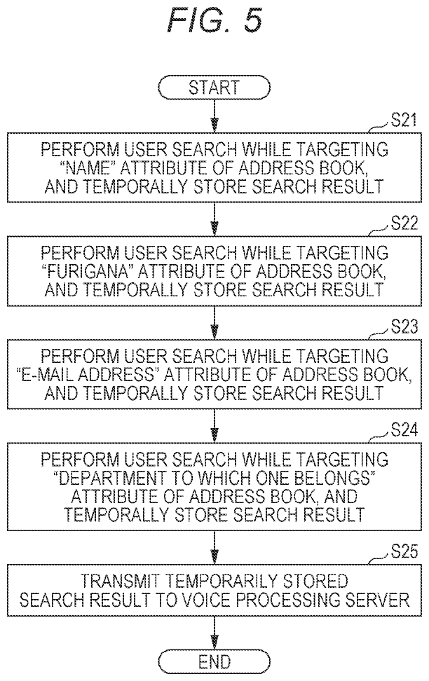

Example 1 of address search processing (one example of term search processing) performed by the image forming apparatus 1 will now be described with reference to FIG. 5. FIG. 5 is a flowchart illustrating an example of a procedure of the address search processing according to Example 1. The processing in FIG. 5 is perforated by the search executor 15 of the image forming apparatus 1 in step S6 in FIG. 4.

First, the search executor 15 of the image forming apparatus 1 searches for a keyword while targeting the user information associated with the “name” attribute of the address book 113a, and temporarily stores the search result in, for example, the RAM 111 and the storage 113 (step S21). If the search result is not found, the search executor 15 temporarily stores information of “No target”. If the search result is found, the search executor 15 temporarily stores information such as “Corresponding one case “TOYOTA TARO””.

The search executor 15 searches for a keyword while targeting the user information associated with the “furigana” attribute of the address book 113a, and temporarily stores the search result (step S22). The search executor 15 searches for a keyword while targeting the user information associated with the “e-mail address” attribute of the address book 113a, and temporarily stores the search result (step S23). The search executor 15 searches for a keyword while targeting the user information associated with the “department to which one belongs” attribute of the address book 113a, and temporarily stores the search result (step S24).

The controller 11 of the image forming apparatus 1 transmits the temporarily stored search result to the voice processing server 4 via the communicator 12 (step S25).

In Example 1 of the invention, when an address search instruction specifying a username as a keyword is t5 given by a voice operation, the search executor 15 of the image forming apparatus 1 performs search targeting not only the “name” attribute but all other attributes. According to the example, it is possible to prevent the occurrence of erroneous determination of no corresponding case due to the mismatch between an attribute of text of a search source and an attribute of the address book 113a of a search destination. According to the example, it is possible to accurately search for an address by a voice operation.

According to the example, the user can perform an accurate address search only by performing a voice operation to the voice input/output apparatus 2 without additionally inputting, for example, an operation to the operation display 14, which saves the user trouble.

In the example, the search executor 15 of the image forming apparatus 1 performs the address search processing, and no special processing is required on the side of the voice input/output apparatus 2. That is, a smart speaker sold by a manufacturer different from the manufacturer of the image forming apparatus 1 can be used as the voice input'output apparatus 2. According to the example, the user can continuously enjoy the benefits of the latest AI functions.

Although, in Example 1 above, an example in which a plurality of searches for a keyword targeting a plurality of attributes is performed temporally in order has been illustrated, the invention is not limited thereto. The plurality of searches for a keyword targeting a plurality of attributes may be performed temporally in parallel. In the case, the time required for the user to obtain a search result can be shortened.

### VARIATION OF EXAMPLE 1

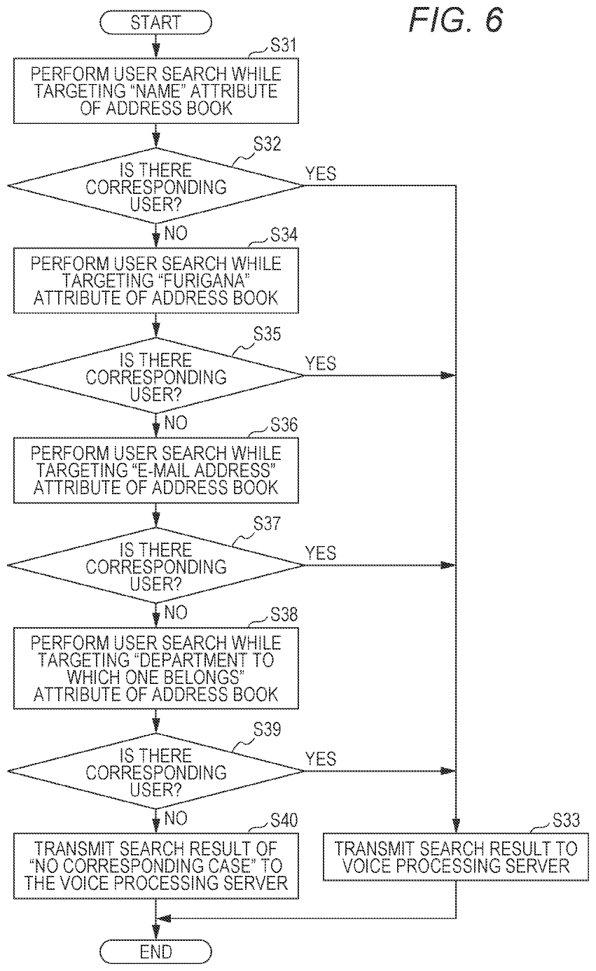

A variation of Example 1 of address search processing performed by the image forming apparatus 1 will now be described with reference to FIG. 6. FIG. 6 is a flowchart illustrating an example of a procedure of the address search processing according to the variation of Example 1.

First, the search executor 15 of the image forming apparatus 1 searches for a keyword while targeting the user information associated with the “name” attribute of the address book 113a (step S31). The search executor 15 determines whether or not a corresponding user (one example of term) is registered in the name attribute of the address book 113a (whether or not there is a corresponding user) (step S32).

When it is determined in step S32 that there exists the corresponding user (YES in step S32), the controller 11 of the image forming apparatus 1 transmits the search result to the voice processing server 4 via the communicator 12 (step S33). After the processing of step S33, the controller 11 ends the address search processing performed by the image forming apparatus 1.

In contrast, when it is determined in step S32 that there exists no corresponding user (NO in step S32), the search executor 15 searches for a keyword while targeting the user information associated with the “furigana” attribute of the address book 113a (step S34). The search executor 15 determines whether or not the corresponding user is registered in the furigana attribute of the address book 113a (step S35).

When it is determined in step S35 that there exists the corresponding user (YES in step S35), the controller 11 of the image forming apparatus 1 performs processing of step S33. That is, the search result is transmitted to the voice processing server 4 via the communicator 12.

In contrast, when it is determined in step S35 that there exists no corresponding user (NO in step S35), the search executor 15 searches for a keyword while targeting the user information associated with the “e-mail address” attribute of the address book 113a (step S36). The search executor 15 determines whether or not the corresponding user is registered in the e-mail address attribute of the address book 113a (step S37).

When it is determined in step S37 that there exists the corresponding user (YES in step S37), the controller 11 of the image forming apparatus 1 performs processing of step S33. That is, the search result is transmitted to the voice processing server 4 via the communicator 12.

In contrast, when it is determined in step S37 that there exists no corresponding user (NO in step S37), the controller 11 of the image forming apparatus 1 searches for a keyword while targeting the user information associated with the “department to which one belongs” attribute of the address book 113a (step S38). The search executor 15 determines whether or not the corresponding user is registered in the “department to which one belongs” attribute of the address book 113a (step S39).

When it is determined in step S39 that there exists the corresponding user (YES in step S39), the controller 11 of the image forming apparatus 1 performs processing of step S33. That is, the search result is transmitted to the voice processing server 4 via the communicator 12.

In contrast, when it is determined in step S39 that there exists no corresponding user (NO in step S39), the controller 11 of the image forming apparatus 1 transmits the search result of “no corresponding case” to the voice processing server 4 via the communicator 12 (step S40). After the processing of step S40, the controller 11 ends the address search processing performed by the image forming apparatus 1.

According to the variation of Example 1 above, the address search processing ends at the time when the address search result is obtained, so that the time for providing the search result to a user can be shortened as compared with that in Example 1.

### EXAMPLE 2

Example 2 of the address search processing performed by the image forming apparatus 1 will now be described. In Example 2, the search executor 15 determines the type of a character (hereinafter, also referred to as “character type”) of text specified as a keyword, and searches the address book 113a while targeting only an attribute preliminary associated with the character type. In the example, the search executor 15 searches the address book 113a with reference to a search target attribute table T1 in which the type of a character of text specified as a keyword and the attribute of a search target are associated with each other.

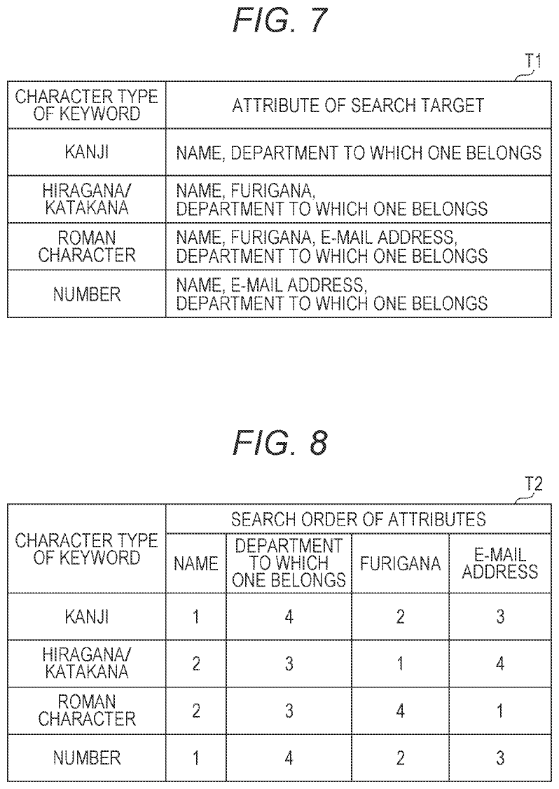

The configuration of the search target attribute table T1 will now he described with reference to FIG. 7. FIG. 7 illustrates a configuration example of the search target attribute table T1. As illustrated in FIG. 7, the search target attribute table T1 includes a field of “Character type of keyword” and a field of “Attribute of search target”. The type of a character of the text specified as a keyword transmitted from the voice processing server 4 is stored in the field of “Character type of keyword”, In the example in FIG. 7, “Kanji”, “Hiragana/Katakana”, “Roman character”, and “Number” are stored as types of character. Information on an attribute associated with the character type of a keyword is stored in the field of “Attribute of search target”.

Specifically, the attributes of “Name” and “Department to which one belongs” are associated with “Kanji” of the character type of a keyword. The attributes of “Name”, “Furigana”, and “Department to which one belongs” are associated with “Hiragana/Katakana” of the character type of a keyword. The attributes of “Name”, “Furigana”, “E-mail address” and “Department to which one belongs” are associated with “Roman character” of the character type of a keyword. The attributes of “Name”, “E-mail address”, and “Department to which one belongs” are associated with “Number” of the character type of a keyword.

For example, when the character type of the text specified as a keyword is “Kanji”, the search executor 15 searches the address book 113a while targeting only the “Name” attribute and the “Department to which one belongs” attribute. For example, when the character type of the text specified as a keyword is “Hiragana/Katakana”, the search executor 15 searches the address book 113a while targeting only the “Name” attribute, the “Furigana” attribute, and the “Department to which one belongs” attribute.

The type of characters used is often determined to some extent for each attribute in the data registered in the address book 113a. For example, in the attribute of “Furigana”, “Hiragana”, “Katakana”, and “Roman character” are used, but “Number” is rarely used. In the attribute of “E-mail address”, “Roman character” and “Number” are used, but other character types are rarely used.

That is, for example, when the character type of the text specified as a keyword is “Number”, the search accuracy is not likely to be deteriorated so much even if the attribute of “Furigana” is removed from the attribute to be targeted. For example, when the character type of the text specified as a keyword is “Hiragana/Katakana”, the search accuracy is not likely to be deteriorated so much even if the attribute of “E-mail address” is removed from the attribute to be targeted.

Even when the attribute of a search target is changed in accordance with the character type of a keyword as in Example 2, the keyword search accuracy is maintained. According to Example 2, search with high accuracy can be performed while time required for a user to obtain a search result is shortened.

Note that, in Example 2, as in the variation of Example 1 above, search may be stopped at the time when a search result is found, and the search result may be presented to a user at that time, in the case, the lime for the user to obtain a search result can be further shortened.

### EXAMPLE 3

Example 3 of the address search processing performed by the image forming apparatus 1 will now be described. In Example 3, the search executor 15 determines the type of a character of text specified as a keyword, and searches the address book 113a while targeting all attributes in accordance with the order of search preliminary associated with the type of the character.

FIG. 8 illustrates a configuration example of an attribute search order table T2 in which a character type of text specified as a keyword and a search order are associated with each other. As illustrated in FIG. 8, the attribute search order table T2 includes a field of “Character type of keyword” and a field of “Search order of attributes”.

The type of a character of the text specified as a keyword transmitted front the voice processing server 4 is stored in the field of “Character type of keyword”. Information on the search order of attributes associated with the character type of a keyword is stored in the field of “Search order of attribute” in numbers.

Specifically, 1: “Name”, 2: “Furigana”, 3: “E-mail address”, and 4: “Department to which one belongs” are associated with “Kanji” of the character type of a keyword as the search order of attributes. Furthermore, 1: “Furigana”, 2: “Name”, 3: “Department to which one belongs”, and 4: “E-mail address” are associated with “Hiragana/Katakana” of the character type of a keyword as the search order of attributes.

Furthermore, 1: “E-mail address”, 2: “Name”, 3: “Department to which one belongs”, and 4: “Furigana” are associated with “Roman character” of the character type of a keyword as the search order of attributes. Furthermore, 1: “Name”, 2: “Furigana”, 3: “E-mail address”, and 4: “Department to which one belongs” are associated with “Number” of the character type of a keyword as the search order of attributes.

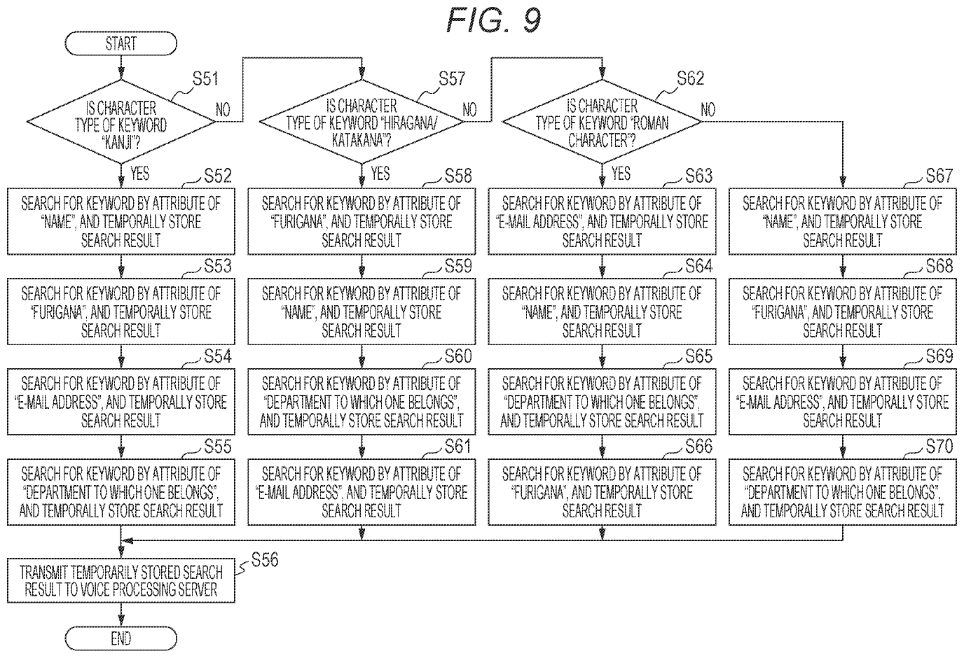

FIG. 9 is a flowchart illustrating an example of a procedure of the address search processing according to Example 3.

First, the search executor 15 of the image forming apparatus 1 determines whether or not the character type of the text specified as a keyword is “Kanji” (step S51). When it is determined in step S51 that the character type of the text is “Kanji” (YES in step S51), the search executor 15 searches for a user (keyword) while targeting user information associated with the “Name” attribute, and temporarily stores the search result (step S52).

The search executor 15 performs search targeting the user information associated with the “Furigana” attribute, and temporarily stores the search result (step S53). The search executor 15 performs search targeting, the user information associated with the “E-mail address” attribute, and temporarily stores the search result (step S54). The search executor 15 performs search targeting the user information associated with the “Department to which one belongs” attribute, and temporarily stores the search result (step S55).

The search executor 15 transmits the temporarily stored search result to the voice processing server 4 (step S56). After the processing of step S56, the controller 11 of the image forming apparatus 1 ends the address search processing.

When it is determined in step S51 that the character type of the text specified as a keyword is not “Kanji” (NO in step S51), the search executor 15 of the image forming apparatus 1 determines whether or not the character type of the text specified as a keyword is “Hiragana/Katakana” (step S57). When it is determined in step S57 that the character type of the text is “Hiragana/Katakana” (YES in step S57), the search executor 15 performs search targeting user information associated with the “Furigana” attribute, and temporarily stores the search result (step S58).

The search executor 15 performs search targeting the user information associated with the “name” attribute, and temporarily stores the search result (step S59). The search executor 15 performs search targeting the “Department to which one belongs” attribute, and temporarily stores the search result (step S60). The search executor 15 performs search targeting the user information associated with the “E-mail address” attribute, and temporarily stores the search result (step S61). The search executor 15 performs the processing of step S56. That is, the search executor 15 transmits the temporarily stored search result to the voice processing server 4.

When it is determined in step S57 that the character type of the text specified as a keyword is not “Hiragana/Katakana” (NO in step S57), the search executor 15 of the image forming apparatus 1 determines whether or not the character type of the text specified as a keyword is “Roman character” (step S62). When it is determined in step S62 that the character type of the text is “Roman character” (YES in step S62), the search executor 15 performs search targeting user information associated with the “E-mail address” attribute, and temporarily stores the search result (step S63).

The search executor 15 performs search targeting the user information associated with the “name” attribute, and temporarily stores the search result (step S64). The search executor 15 performs search targeting the user information associated with the “Deportment to which one belongs” attribute, and temporarily stores the search result (step S65). The search executor 15 performs search targeting the user information associated with the “Furigana” attribute, and temporarily stores the search result (step S66). The search executor 15 performs the processing of step S56. That is, the search executor 15 transmits the temporarily stored search result to the voice processing server 4.

When it is determined in step S62 that the character type of the text specified as a keyword is not “Roman character” (NO in step S62), the search executor 15 determines that the character type is “Number”. The search executor 15 performs search targeting the user information associated with the “name” attribute, and temporarily stores the search result (step S67).

The search executor 15 performs search targeting the user information associated with the “Furigana” attribute, and temporarily stores the search result (step S68), The search executor 15 performs search targeting the user information associated with the “E-mail address” attribute, and temporarily stores the search result (step S69). The search executor 15 performs search targeting the user information associated with the “Department to which one belongs” attribute, and temporarily stores the search result (step S70). The search executor 15 performs the processing of step S56. That is, the search executor 15 transmits the temporarily stored search result to the voice processing server 4.

As described in the description of Example 2, the type of characters used is often determined to some extent for each attribute in the data registered in the address book 113a. The search order is determined so that the search is perforated in order from an attribute considered to be highly relevant, and the search executor 15 performs search in the order. Thereby, tune to obtain the corresponding search result can be shortened.

In the variation of Example 1, the search executor 15 stops search at the time when the corresponding search result is found. Consequently, when the corresponding search result is found, some attributes remain unsearched. When search targeting unsearched attributes is performed, however, a more appropriate search result of the text specified as a keyword may be found. In the case, it can be said that the determination result indicating that there is a corresponding search result is an erroneous determination.

In Example 3, since search targeting all attributes is performed, the possibility that such an erroneous determination is performed can be further reduced. Note that, in Example 3, when a plurality of corresponding search results is found, the plurality of search results is presented by, for example, display on the operation display 14 or output of a message from the voice input/output apparatus 2, and processing such as selection of the search results performed by a user is performed. A search result that matches user intention thereby can be identified.

Although, in FIG. 9, an example in which the search executor 15 determines the character type of a keyword in order of “Kanji”, “Hiragana/Katakana”, “Roman character”(, and “Number”) has been described, the invention is not limited thereto. The search executor 15 may determine the character types of a keyword in order different from the order illustrated in the example of FIG. 9.

Also, in Example 3, the search executor 15 may stop the search at the time when a search result is found in order to shorten the time for the user to obtain the search result, and transmit the search result to the voice processing server 4.

<Various Variations>

Note that the invention is not limited to the above-described embodiment, and various other applications and variations can be exhibited without departing from the gist of the invention set forth in the claims.

Although, in each of the above-described examples and variations, an example in which the search executor 15 is provided in the image forming apparatus 1 has been described, the invention is not limited thereto. The search executor may be provided in the voice processing server 4.

Although, in each of the above-described examples and variations, an example in which the address book 113a is stored in the image forming apparatus 1 has been described, the invention is not limited thereto. The address book 113a may be provided in, for example, the voice processing server 4, a server (not illustrated) on a cloud, and an on-premises server (not illustrated).

Although, in each of the examples and variations, an example in Which information management data is the address book 113a and a term specified as a keyword is a username has been described, the invention is not limited thereto. The information management data is only required to be data in which a plurality of pieces of attribute information is associated with each of a plurality of terms. The term specified as a keyword may be a term other than the username.

Although, in each of the above-described examples and variations, an example in which an information processing apparatus of the invention is applied to the image forming apparatus 1 has been described, the invention is not limited thereto. The information processing apparatus of the invention may be applied to another apparatus other than the image forming apparatus 1 as long as the information processing apparatus operates by a voice operation, and can perform search targeting the information management data.

Although, in each of the above-described examples and variations, an example in which a smart speaker is used as the voice input/output apparatus 2 has been described, the invention is not limited thereto. A mobile terminal, which includes a mobile phone terminal and a smartphone, held by the user U may be used as the voice input/output apparatus 2.

Although embodiments of the present invention have been described and illustrated in detail, the disclosed embodiments are made for purposes of illustration and example only and not limitation. The scope of the present invention should be interpreted by terms of the appended claims.

What is claimed is:

1. An information processing apparatus comprising:
a communicator that receives a search instruction for a term generated based on an instruction uttered by a user; and
a search executor that performs search targeting each piece of information associated with a plurality of attributes in information management data in which the plurality of attributes is associated with information related to the term by using the term contained in the search instruction received by the communicator as a keyword, and outputs a search result to the communicator and/or a display.

2. The information processing apparatus according to claim 1,
wherein the search executor performs a plurality of searches for the information associated with the plurality of attributes temporally in parallel.

3. The information processing apparatus according to claim 1,
wherein the search executor performs a plurality of searches for the information associated with the plurality of attributes temporally in order.

4. The information processing apparatus according to claim 3,
wherein the search executor outputs a search result that matches the term to the communicator or the display at a time when the search result is obtained.

5. The information processing apparatus according to claim 2,
wherein the search executor determines a type of a character constituting the term contained in the search instruction received by the communicator, and performs search for the term while targeting the information of the attributes preliminary associated with the determined type of the character.

6. The information processing apparatus according to claim 3,
wherein the search executor determines a type of a character constituting the term contained in the search instruction received by the communicator, and performs search for the term while targeting the information of the attributes preliminary associated with the determined type of the character in order associated with the type of the character.

7. The information processing apparatus according to claim 2,
wherein the search executor determines a type of a character constituting the term contained in the search instruction received by the communicator, and performs search for the information while targeting all the plurality of attributes in order associated with the type of the character.

8. The information processing apparatus according to claim 1,
wherein the term is a username, and the information management data is an address book of the user.

9. A term search method comprising:
receiving a search instruction for a term generated based on an instruction uttered by a user; and
performing search targeting each piece of information associated with a plurality of attributes in information management data in which the plurality of attributes is associated with information related to the term by using the term contained in the received search instruction as a keyword, and outputting a search result.

10. A non-transitory recording, medium storing a computer readable program causing an information processing apparatus to execute:
receiving a search instruction for a term generated based on an instruction uttered by a user; and
performing search targeting each piece of information associated with a plurality of attributes in information management data in which the plurality of attributes is associated with information related to the term by using the term contained in the received search instruction as a keyword, and outputting a search result.
